(19) United States
(12) Patent Application Publication
(10) Pub. No.: US 2012/0230393 A1
(43) Pub. Date: Sep. 13, 2012

(54) METHODS AND APPARATUSES FOR ENCODING AND DECODING VIDEO USING ADAPTIVE INTERPOLATION FILTER LENGTH

(76) Inventors: Sue Mon Thet NAING, Singapore (SG); Chong Soon Lim, Singapore (SG); Viktor Wahadaniah, Singapore (SG); Takahiro Nishi, Nara (JP); Youji Shibahara, Osaka (JP); Hisao Sasai, Osaka (JP); Toshiyasu Sugio, Osaka (JP)

(21) Appl. No.: 13/413,947

(22) Filed: Mar. 7, 2012

Related U.S. Application Data
(60) Provisional application No. 61/450,290, filed on Mar. 8, 2011.

(51) Int. Cl. H04N 7/34

(52) U.S. Cl. 375/240.02; 375/E07.133; 375/E07.125

(57) ABSTRACT

Recent video coding schemes support different size of interpolation filter length for interpolation process. However, the schemes are using fixed, one sized interpolation filter length for all different size of picture resolutions and all different size of inter predicted units, leading to undesired large memory bandwidth usage. Especially for large spatial resolution images or large prediction blocks, the required memory bandwidth is substantially increased by using fixed interpolation filter length. The current invention provides methods and apparatuses for selecting the different interpolation filter coefficients adaptively based on a pre-determined interpolation filter length selection scheme. The benefit of the current invention is in the form of saving memory bandwidth usage.

### CROSS REFERENCE TO RELATED APPLICATION

The present application claims the benefit of U.S. Provisional Patent Application No. 61/450,290 filed Mar. 8, 2011. The entire disclosures of the above-identified applications, including the specifications, drawings and claims are incorporated herein by reference in their entirety.

### TECHNICAL FIELD

This invention can be used in any multimedia data coding and, more particularly, in image and video coding.

### BACKGROUND ART

State-of-the-art video coding schemes, such as MPEG-4 AVC/H.264, and the upcoming HEVC (High-Efficiency Video Coding), support different size of interpolation filter length for interpolation process. However, the schemes are using fixed, one sized interpolation filter length for all different size of picture resolutions and all different size of inter predicted units, leading to undesired large memory bandwidth usage.

Large memory access bandwidth is a primarily concern for the implementation of a video encoder or a video decoder. For example, video applications that requires to support large spatial resolution images (example 1920 pixels by 1080 pixels), reducing memory bandwidth is a key step to reduce implementation cost and power consumption.

### SUMMARY OF INVENTION

### Technical Problem

The problem with the prior arts for interpolation process is requiring large memory bandwidth by using fixed interpolation filter length for all different size of picture and all different size of prediction blocks. Especially for large spatial resolution images or large prediction blocks size, the required memory bandwidth is substantially increased by using fixed interpolation filter length and leading to undesired large memory bandwidth.

### Solution to Problem

To solve this problem, new methods for adaptive interpolation filter length selection scheme is introduced. The new method allows for interpolation process using different interpolation filter length for different picture resolution or different prediction blocks.

What is novel about this invention is that when adaptive interpolation filter length is used, the current invention adaptively selects the best mode of interpolation filter length to reduce a required memory bandwidth. Moreover, the flexibility for selecting interpolation filter length scheme is increased.

### Advantageous Effects of Invention

The effect of the current invention is in the form of reducing memory bandwidth usage as current invention support adaptive selection scheme to select different interpolation filter length according to a size of an image resolution or according to a size of a prediction block.

### BRIEF DESCRIPTION OF DRAWINGS

These and other objects, advantages and features of the invention will become apparent from the following description thereof taken in conjunction with the accompanying drawings that illustrate a specific embodiment of the present invention. In the Drawings:

[FIG. 1]

FIG. 1 shows a block diagram illustrating an example apparatus for a video encoder using current invention;

[FIG. 2]

FIG. 2 shows a block diagram illustrating an example apparatus for a video decoder using current invention;

[FIG. 3]

FIG. 3 shows a flowchart illustrating video encoding process of adaptive interpolation filter length using current invention;

[FIG. 4]

FIG. 4 shows a flowchart illustrating video decoding process of adaptive interpolation filter length using current invention;

[FIG. 5]

FIG. 5 shows a flowchart illustrating 1st example of deriving a set of interpolation filter coefficients using current invention;

[FIG. 6]

FIG. 6 shows a flowchart illustrating 2nd example of deriving a set of interpolation filter coefficients using current invention;

[FIG. 7A]

FIG. 7A shows a Diagram showing examples of the locations of the signal indicating the selection of interpolation filter length scheme in a compressed video stream using current invention;

[FIG. 7B]

FIG. 8B shows a Diagram showing examples of the locations of the signal indicating the selection of interpolation filter length scheme in a compressed video stream using current invention;

[FIG. 7C]

FIG. 9C shows a Diagram showing examples of the locations of the signal indicating the selection of interpolation filter length scheme in a compressed video stream using current invention;

[FIG. 7D]

FIG. 10D shows a Diagram showing examples of the locations of the signal indicating the selection of interpolation filter length scheme in a compressed video stream using current invention;

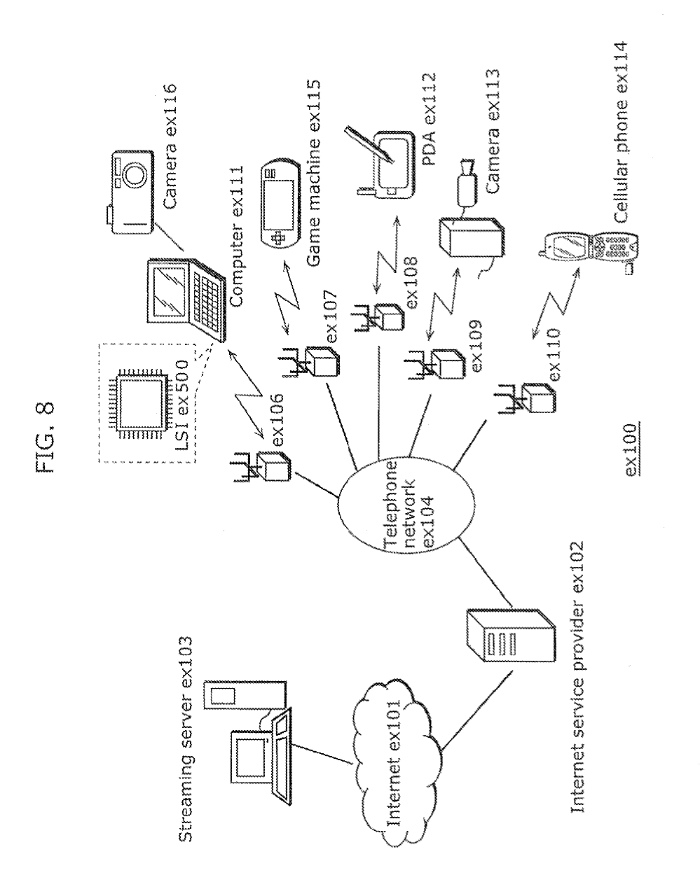

[FIG. 8]

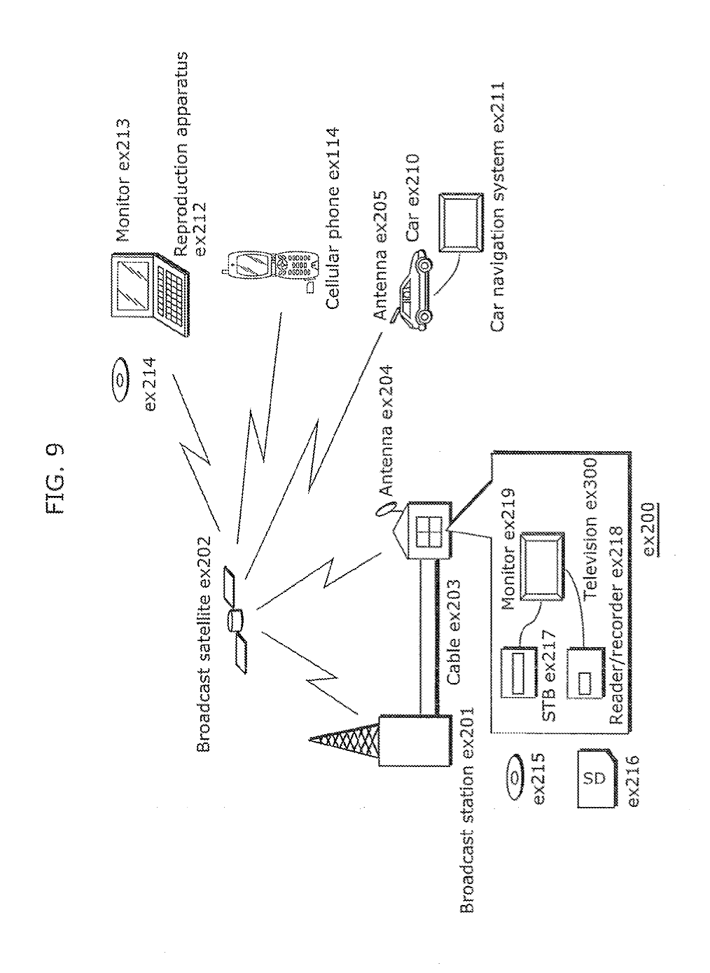

FIG. 8 shows an overall configuration of a content providing system for implementing content distribution services;

[FIG. 9

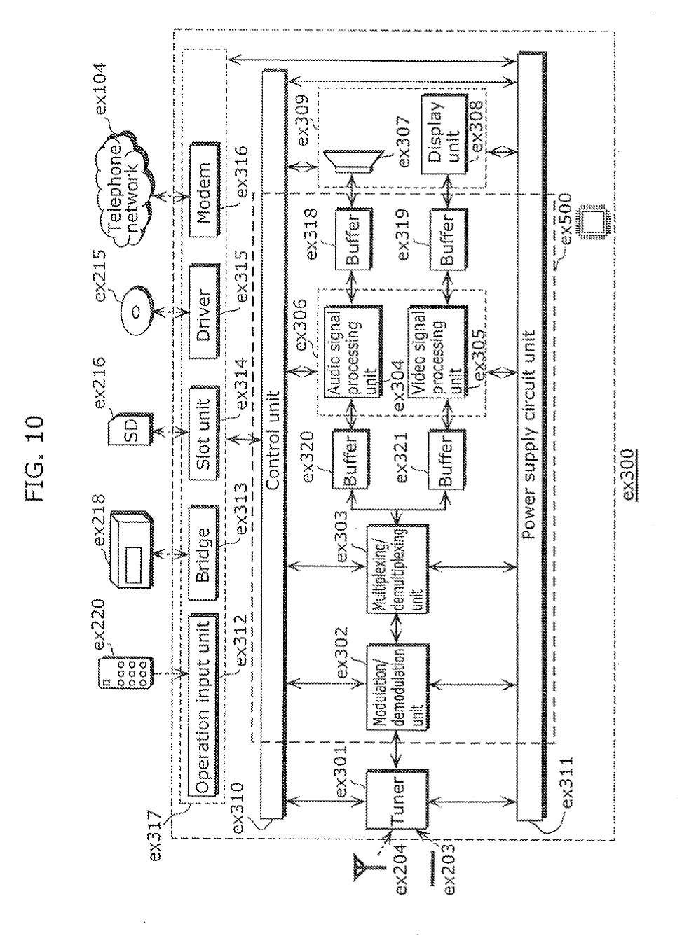

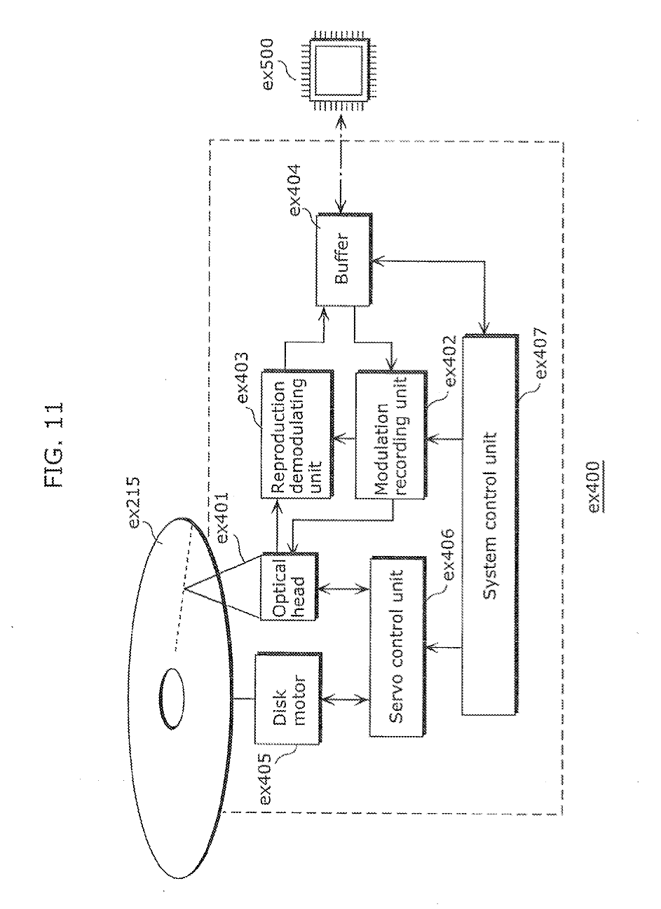

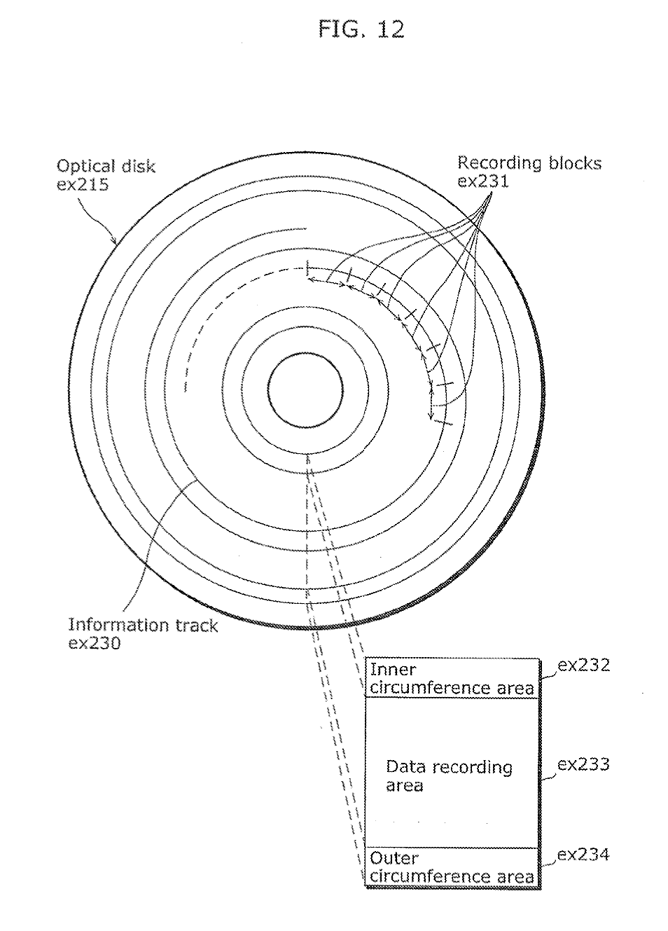

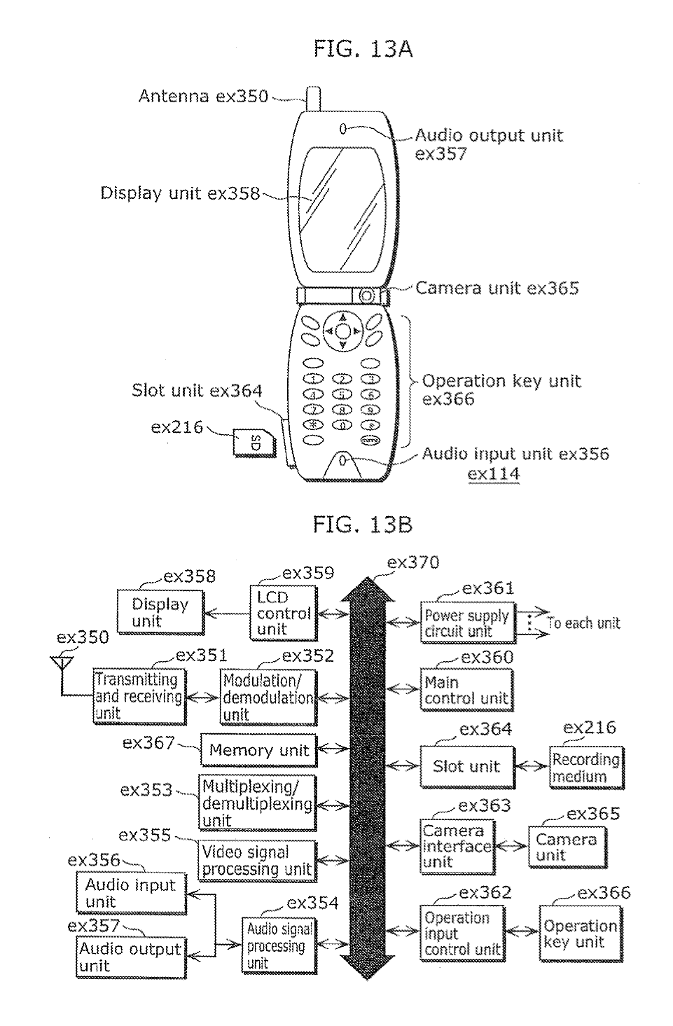

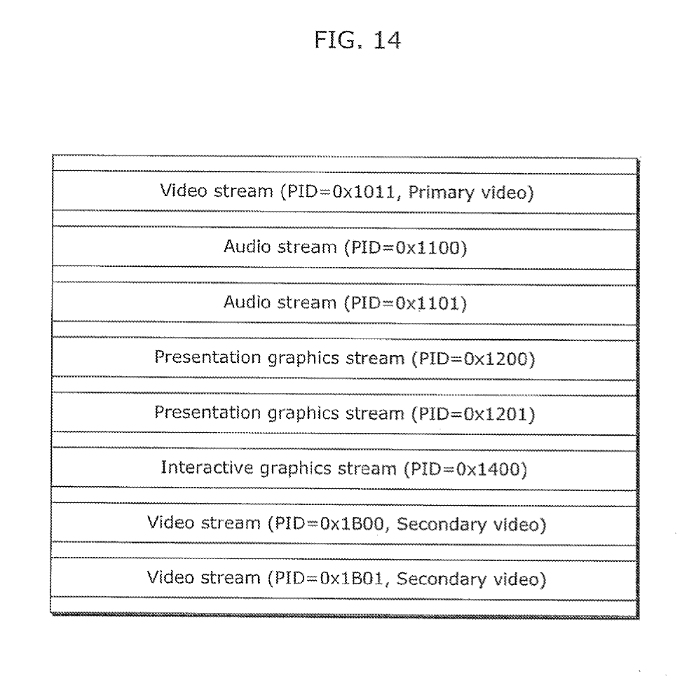

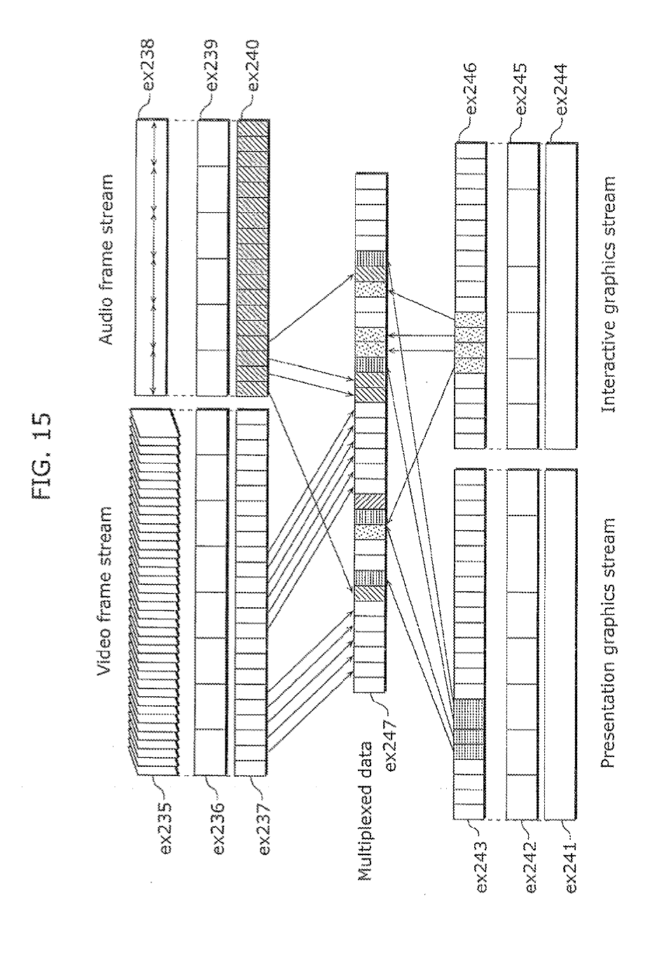

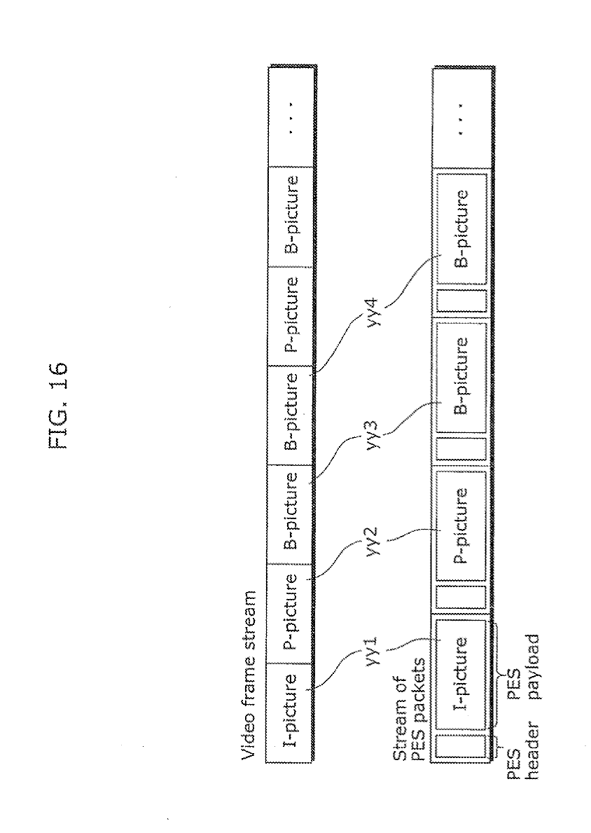

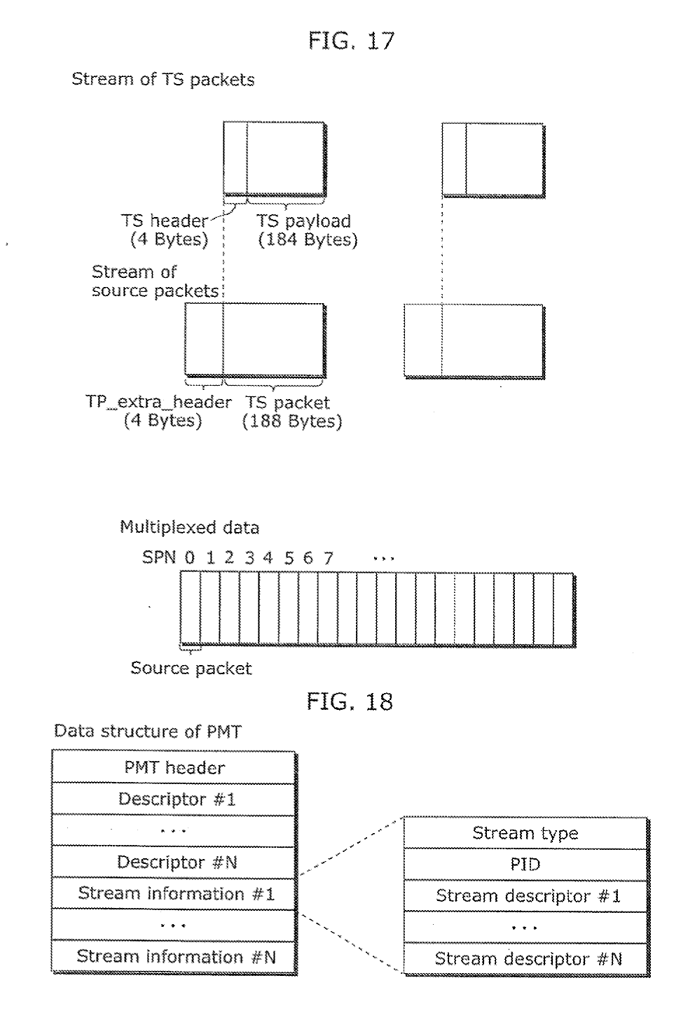

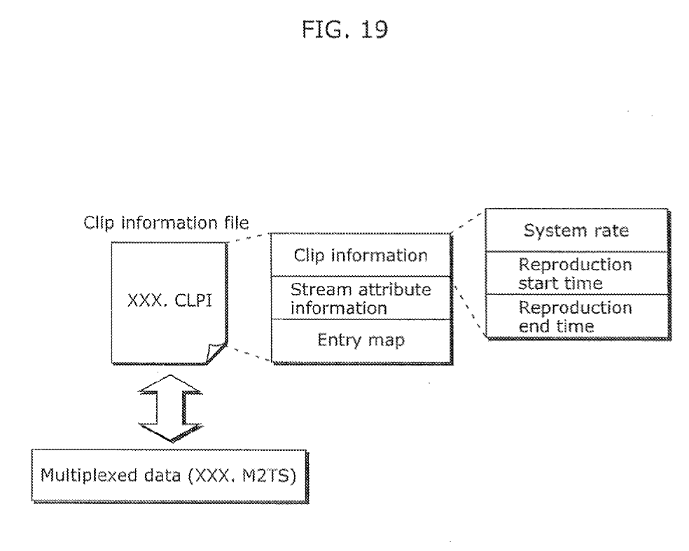

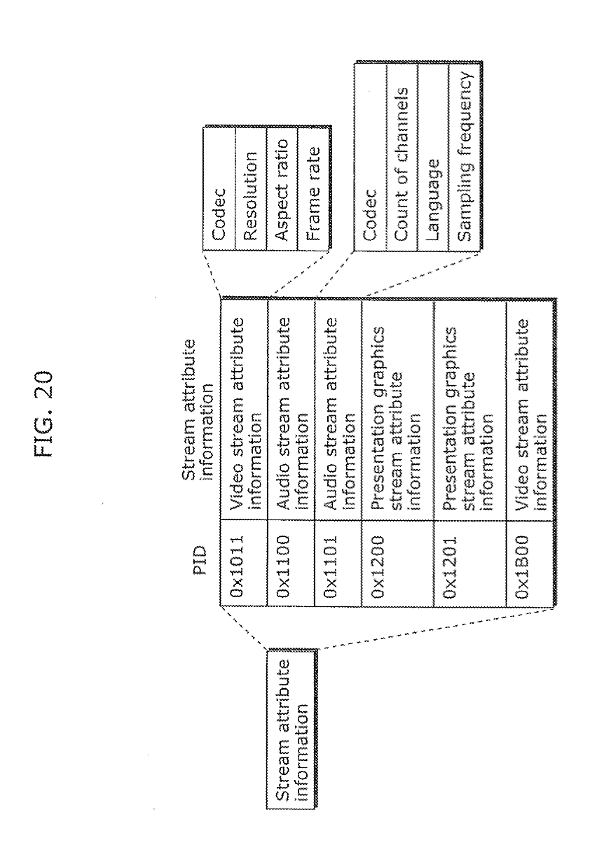

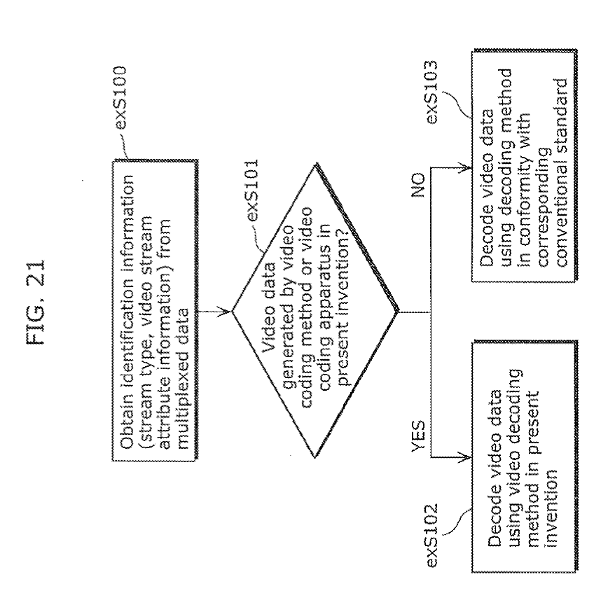

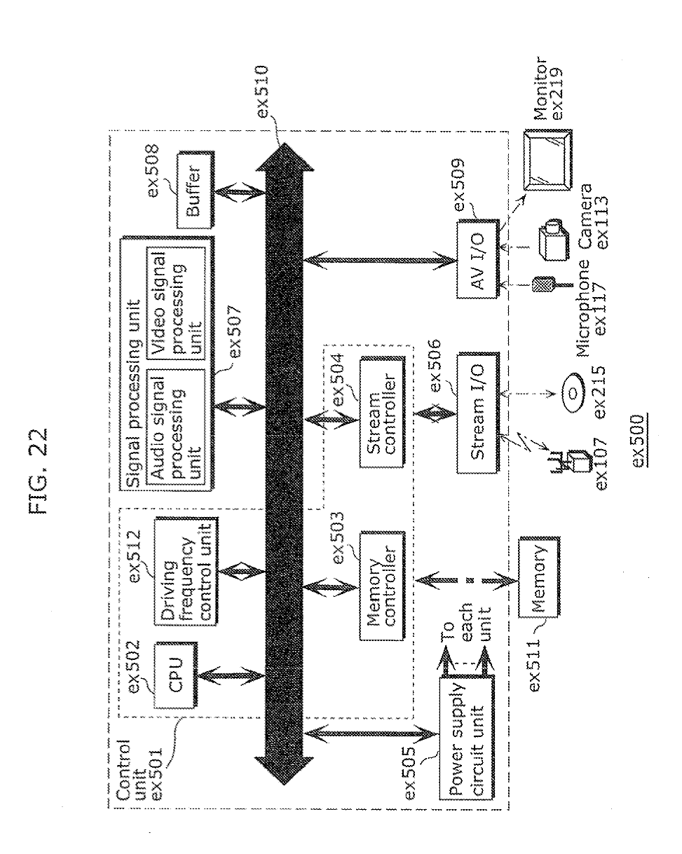

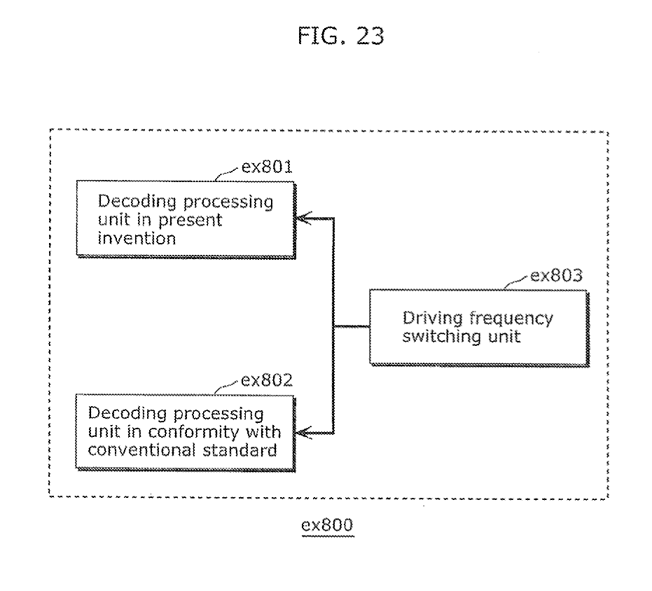

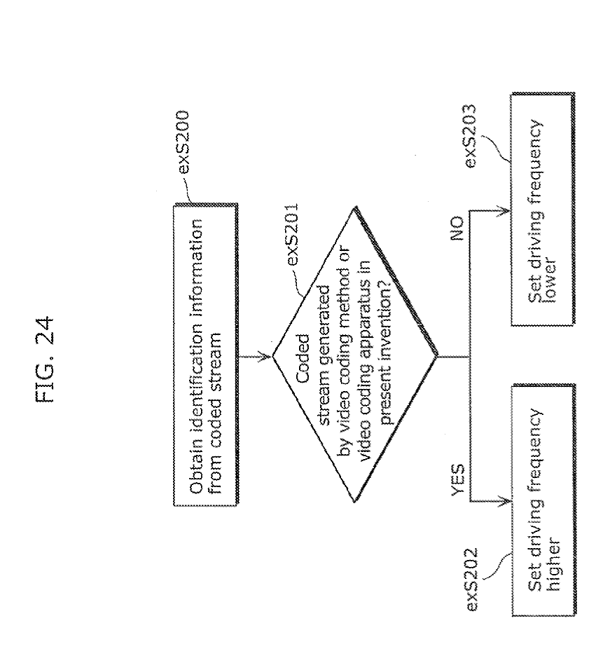

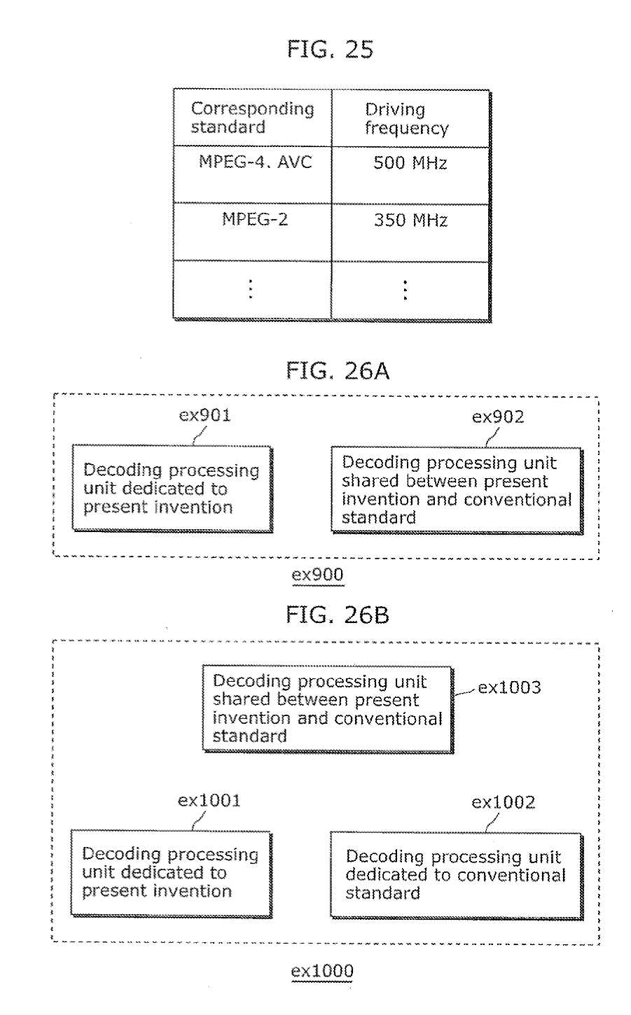

FIG. 9 shows an overall configuration of a digital broadcasting system;

[FIG. 10]

FIG. 10 shows a block diagram illustrating an example of a configuration of a television;

[FIG. 11]

FIG. 11 shows a block diagram illustrating an example of a configuration, of an information reproducing/recording unit that reads and writes information from and on a recording medium that is an optical disk;

[FIG. 12]

FIG. 12 shows an example of a configuration of a recording medium that is an optical disk;

[FIG. 13A]

FIG. 13A shows an example of a cellular phone;

[FIG. 13B]

FIG. 13B is a block diagram showing an example of a configuration of a cellular phone;

[FIG. 14]

FIG. 14 illustrates a structure of multiplexed data;

[FIG. 15]

FIG. 15 schematically shows how each stream is multiplexed in multiplexed data;

[FIG. 16]

FIG. 16 shows how a video stream is stored in a stream of PES packets in more detail;

[FIG. 17]

FIG. 17 shows a structure of TS packets and source packets in the multiplexed data;

[FIG. 18]

FIG. 18 shows a data structure of a PMT;

[FIG. 19]

FIG. 19 shows an internal structure of multiplexed data information;

[FIG. 20]

FIG. 20 shows an internal structure of stream attribute information;

[FIG. 21]

FIG. 21 shows steps for identifying video data;

[FIG. 22]

FIG. 22 shows an example of a configuration of an integrated circuit for implementing the moving picture coding method and the moving picture decoding method according to each of Embodiments;

[FIG. 23]

FIG. 23 shows a configuration for switching between driving frequencies;

[FIG. 24]

FIG. 24 shows steps for identifying video data and switching between driving frequencies;

[FIG. 25]

FIG. 25 shows an example of a look-up table in which video data standards are associated with driving frequencies;

FIG. 26A]

FIG. 26A is a diagram showing an example of a configuration for sharing a module of a signal processing unit; and

[FIG. 26B]

FIG. 26B is a diagram showing another example of a configuration for sharing a module of the signal processing unit.

### DESCRIPTION OF EMBODIMENTS

### Embodiment 1

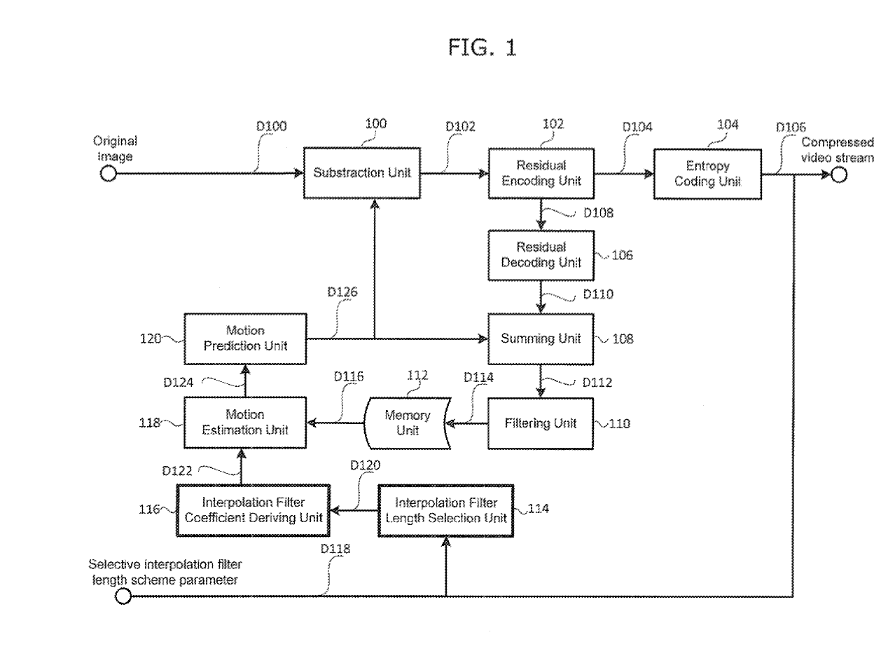

FIG. 1 shows a block diagram illustrating an example apparatus for a video encoder using current invention. It includes a subtraction unit 100, a residual encoding unit 102, an entropy coding unit 104, a residual decoding unit 106, a summing unit 108, a filtering unit 110, a memory unit 112, an interpolation filter length selection unit 114, an interpolation'filter coefficient deriving unit 116, a motion estimation unit 118, and a motion prediction unit 120.

As shown in FIG. 1, the subtraction unit 100 takes original samples D100 of the target picture and subtracts with prediction samples D126 to output residual values D102. The residual encoding unit 102 takes the residuals D102 and output compressed residual coefficients D104. The compressed residual coefficients D104 are then entropy coded by the entropy coding unit 104 and outputs into a compressed video D106. The residual decoding unit 106 takes the compressed residual coefficients D108 and outputs decoded residual values D110. The summing unit 108 takes the residual values D110 and adds with the inter-picture prediction values D126 to reconstruct the image samples D112. The filtering unit 110 reads the reconstructed image samples D112 and outputs filtered image samples D114 to be stored in the memory unit 112.

The interpolation filter length selection unit 114 reads a selective interpolation filter length scheme parameter D118 and compare with a stored, pre-defined parameter. Then, it outputs a selected interpolation filter length scheme D120. The interpolation filter coefficient deriving unit reads the selected interpolation filter length scheme D120 and derives a set of interpolation filer coefficients D122 into the motion estimation unit 118. The motion estimation unit 118 reads the derived interpolation filer coefficients D122 and stored image samples D116 from the memory unit 112, then estimate motion vectors. The motion estimation unit outputs the motion vectors, the derived interpolation filer coefficients, and image samples D124 to the motion prediction unit 120. The motion prediction unit 120 reads the motion vectors, the derived interpolation filer coefficients, and image samples D124 and outputs inter-picture prediction samples D126.

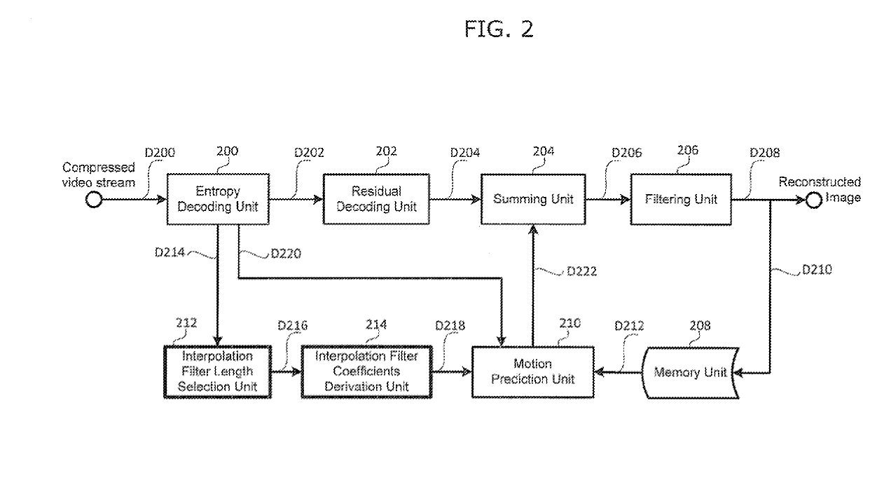

FIG. 2 shows a block diagram illustrating an example apparatus for a video decoder using current invention. It includes an entropy decoding unit 200, a residual decoding unit 202, a summing unit 204, a filtering unit 206, a memory unit 208, a motion prediction unit 210, an interpolation filter length selection unit 212, and an interpolation filter coefficient deriving unit 214.

As shown in FIG. 2, the entropy decoding unit 200 reads a compressed video D200 and outputs the compressed residual coefficients D202. The entropy decoding unit 200 also parses a selective interpolation filter length parameter D214 of a target picture from the header of the compressed video stream D200. The entropy decoding unit also decodes the motion vectors and reference indices D220 from the compressed video stream D200. The residual decoding unit 202 reads the compressed residual coefficients D202 and outputs decoded residual values D204. The summing unit 204 reads the residual value D204 and inter-picture predicted samples D222 to output reconstructed samples D206. The filtering unit 206 reads the reconstructed samples D206 and outputs filtered samples D208.

The interpolation filter length selection unit 214 reads a selective interpolation filter length scheme parameter D214 and compare with a stored, pre-defined parameter. Then, it outputs a selected interpolation filter length scheme D216. The interpolation filter coefficient deriving unit reads the selected interpolation filter length scheme D216 and derives a set of interpolation filer coefficients D128. The motion prediction unit 210 reads the motion vectors and reference indices D220, the set of interpolation filer coefficients D218, and stored image samples D212, then outputs inter-picture prediction samples D222.

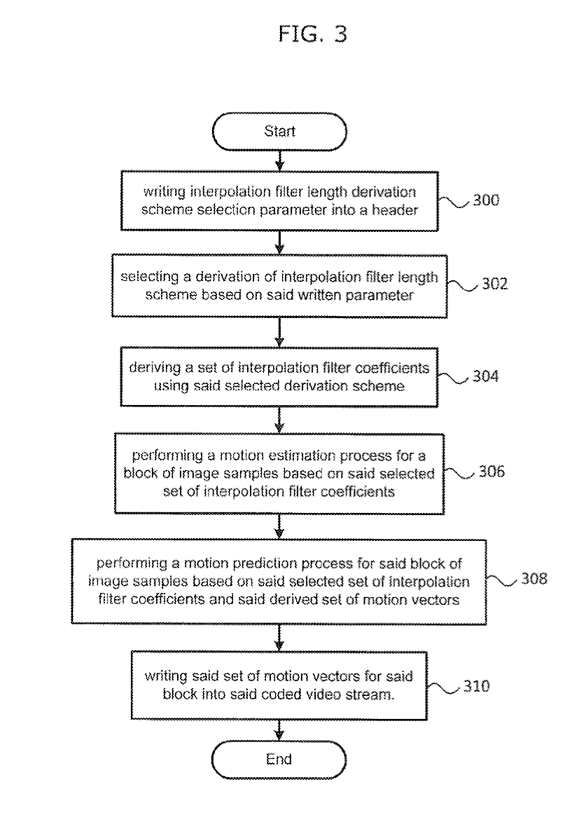

FIG. 3 shows a flowchart illustrating a video encoding process using current invention. Firstly in module 300, an identified parameter for interpolation filter length scheme is written into a header of video stream.

Based on said written parameter, module 302 selects an interpolation filter length scheme by comparing the written parameter with stored, pre-determined parameter.

One example case of selecting an interpolation filter length scheme, where pre-determined schemes contain only one scheme for selection, the operations of module 300 and module 302 can be skipped.

After selecting the filer length scheme, module 304 derives a set of interpolation filter coefficients using said selected derivation scheme.

Next, module 306 performs a motion estimation process for a block of image samples based on said selected set of interpolation filter coefficients to derive a set of motion vectors. Then, continuing with module 308 for motion prediction process according to said selected set of interpolation filter coefficients and said derived set of motion vectors.

After the process, module 310 writes said set of motion vectors for the block in a header of a compressed video stream.

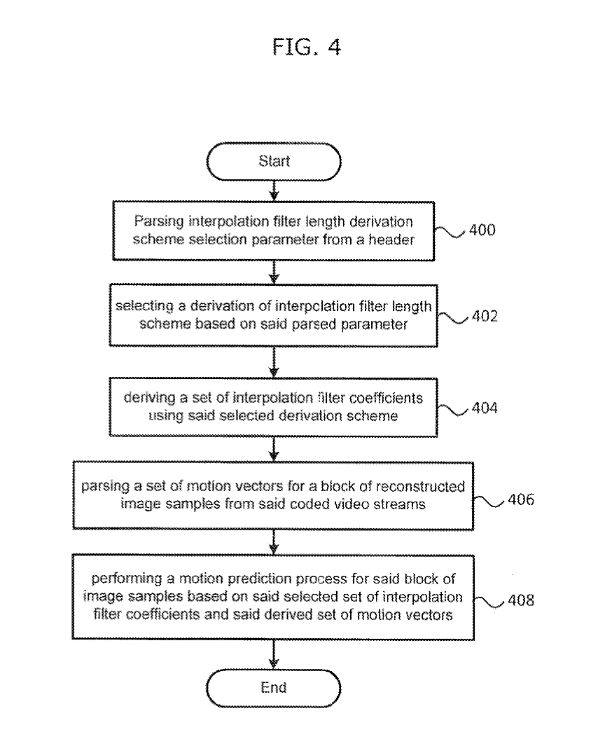

FIG. 4 shows a flowchart illustrating a video decoding process using current invention. As shown in the figure, in module 400, an identified parameter for interpolation filter length scheme is first parsed from a header of a coded video stream to determine a scheme.

In module 402, the scheme for interpolation filter length is selected by comparing the parsed parameter of selective interpolation filter length scheme with stored, pre-determined parameter.

In the case of selecting an interpolation filter length scheme, where pre-determined schemes contain only one scheme, the operations of module 400 and module 402 can be skipped. Next in module 404, a set of interpolation filter coefficients is derived according to selected interpolation filter length scheme.

And in module 406, a set of motion vectors for a block of reconstructed image samples are parsed from said coded video stream.

Then, it performs motion prediction for said block of image samples in module 408 based on selected set of interpolation filter coefficients and derived motion vectors.

According to FIG. 3 and FIG. 4 descriptions, the identified parameter for interpolation filter length scheme may be profile parameter which indicates the complexity of image reconstructing process or level parameter which specifies a set of constraints, indicating a degree of required decoder performance for a profile.

The interpolation filter length scheme identified parameter may contain weight or height information of the target picture, the spatial size of each prediction block or relevant parameters to determine the size of the prediction block.

Alternatively, the parameter for selective interpolation filter length scheme can be applied according to slice type (example, P or B picture) or prediction type of a block (example uni-prediction or bi-perdition). Example use case is applying larger interpolation filter length for P-picture or uni-prediction type and applying shorter interpolation filter length for B-picture or bi-prediction type.

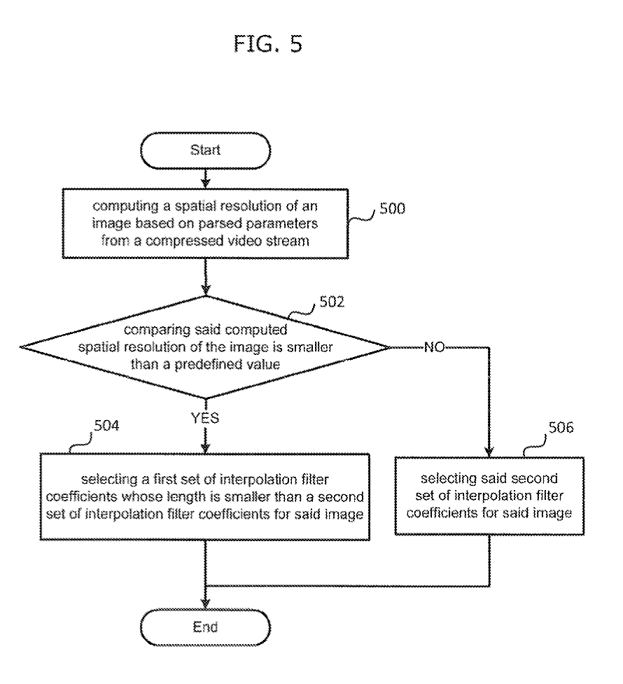

FIG. 5 shows a flowchart illustrating 1st example of deriving a set of interpolation filter coefficients using current invention. The module 500 identifies a parameter to judge a size of a picture received from a header of a video stream, and then it determines a resolution of said picture.

And in module 502, a comparison is made to see if the determined resolution of the image size is smaller than a stored, pre-defined image size.

If the determined resolution of the image is smaller than the pre-defined image size, a first set of interpolation filter coefficients is selected in module 504 and a motion interpolation process is performed for a block of image samples using the first set of interpolation filter coefficients.

If the determined resolution of the image is not smaller than the pre-defined image size, then a second set of interpolation filter coefficients is selected in module 506 and a motion interpolation process is performed for a block of image samples using the second set of interpolation filter coefficients.

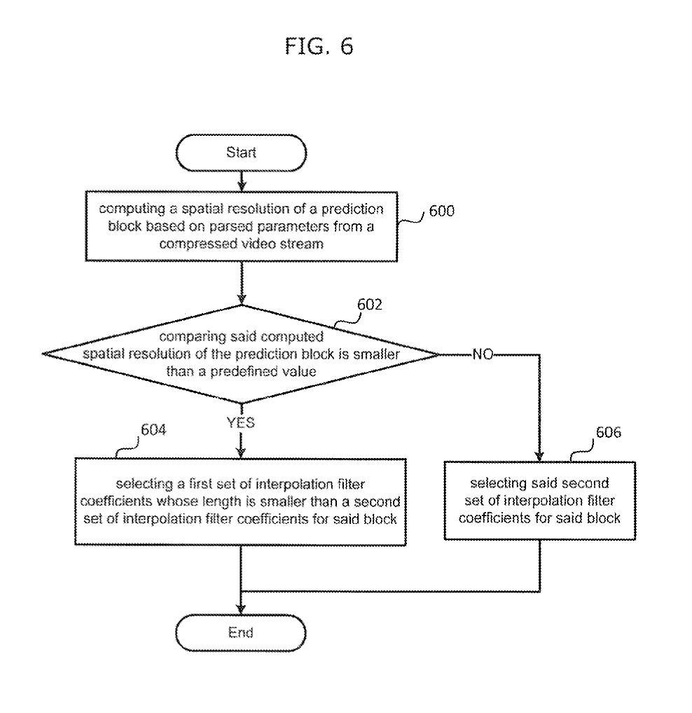

FIG. 6 shows a flowchart illustrating 2nd example of deriving a set of interpolation filter coefficients using current invention. Once the module 600 identifies a parameter to judge a size of a prediction block received from a header of a video stream, it determines a resolution of said prediction block.

And in module 602, a comparison is made to see if the determined resolution of the prediction block size is smaller than a stored, pre-defined, prediction block size.

If the determined resolution of the prediction block is smaller than the pre-defined prediction block size, a first set of interpolation filter coefficients is selected in module 604 and a motion interpolation process is performed for a block of image samples using the first set of interpolation filter coefficients.

If the determined resolution of the prediction block is not smaller than the pre-defined prediction block size, then a second set of interpolation filter coefficients is selected in module 606 and a motion interpolation process is performed for a block of image samples using the second set of interpolation filter coefficients.

In description of FIG. 5 and FIG. 6, the word, “resolution” or “size” may represent a width or a height or both width and height, describing its size in total area, in spatial domain. And an assumption is made that the first set of interpolation filter coefficients is smaller than the second set of interpolation filter coefficients.

When selecting a first set of interpolation filer coefficient, it is assumed that a fixed interpolation filer length scheme is used. When selecting a second set of interpolation filer coefficient, it is assumed that a derivation scheme of interpolation filter length is used.

In current invention, set of interpolation filter coefficients is a group of filter coefficients having the same number of filter coefficients as selected length for filter coefficients during interpolation process.

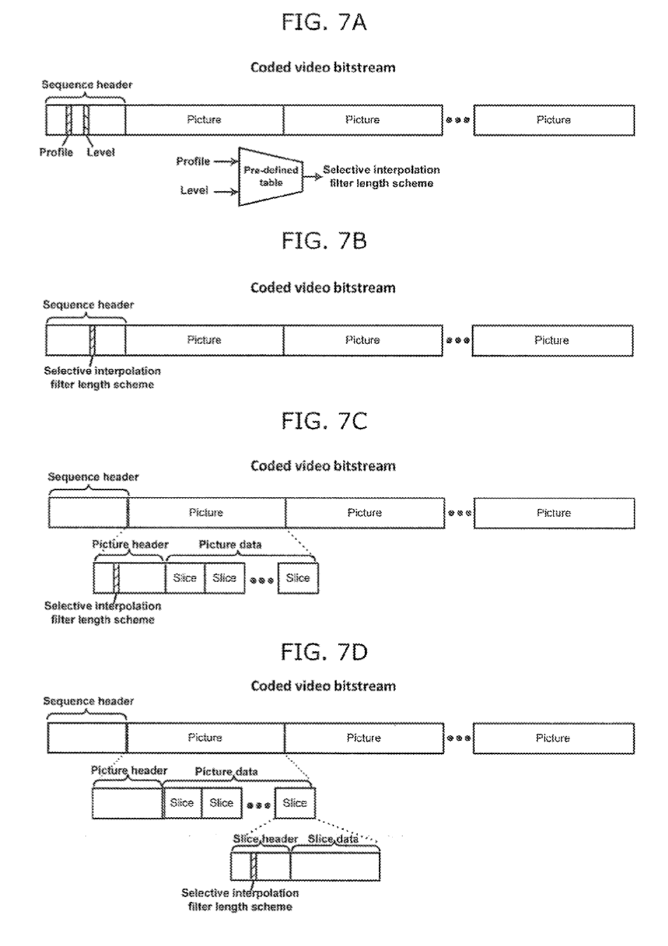

FIG. 7A, FIG. 7B, FIG. 7C, and FIG. 7D show examples of the locations of the parameter indicating the selection of interpolation filter length scheme in a compressed video stream using current invention.

In FIG. 7A, a selective interpolation filter length scheme can be determined by comparing the parameter from profile parameter or level parameter or both profile and level parameters with pre-determined parameter.

As shown in FIG. 7B, a selective interpolation filter length scheme can be found in sequence header of a coded video stream. As shown in FIG. 7C, a selective interpolation filter length scheme can be found in picture header of a coded video stream. As shown in FIG. 7D, a selective interpolation filter length scheme can be found in slice header of a coded video stream.

### Embodiment 2

The processing described in each of embodiments can be simply implemented in an independent computer system, by recording, in a recording medium, a program for implementing the configurations of the moving picture coding method (image coding method) and the moving picture decoding method (image decoding method) described in each of embodiments. The recording media may be any recording media as long as the program can be recorded, such as a magnetic disk, an optical disk, a magnetic optical disk, an IC card, and a semiconductor memory.

Hereinafter, the applications to the moving picture coding method (image coding method) and the moving picture decoding method (image decoding method) described in each of embodiments and systems using thereof will be described. The system has a feature of having an image coding and decoding apparatus that includes an image coding apparatus using the image coding method and an image decoding apparatus using the image decoding method. Other configurations in the system can be changed as appropriate depending on the cases.

FIG. 8 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 8, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital video camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of embodiments (i.e., the camera functions as the image coding apparatus according to an aspect of the present invention), and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (i.e., functions as the image decoding apparatus according to an aspect of the present invention).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the image data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

Aside from the example of the content providing system ex100, at least one of the moving picture coding apparatus (image coding apparatus) and the moving picture decoding apparatus (image decoding apparatus) described in each of embodiments may be implemented in a digital broadcasting system ex200 illustrated in FIG. 9. More specifically, a broadcast station ex201 communicates or transmits, via radio waves to a broadcast satellite ex202, multiplexed data obtained by multiplexing audio data and others onto video data. The video data is data coded by the moving picture coding method described in each of embodiments (i.e., data coded by the image coding apparatus according to an aspect of the present invention). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (i.e., functions as the image decoding apparatus according to an aspect of the present invention).

Furthermore, a reader/recorder ex218 (i) reads and decodes the multiplexed data recorded on a recording media ex215, such as a DVD and a BD, or (i) codes video signals in the recording medium ex215, and in some cases, writes data obtained by multiplexing an audio signal on the coded data. The reader/recorder ex218 can include the moving picture decoding apparatus or the moving picture coding apparatus as shown in each of embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

FIG. 10 illustrates the television (receiver) ex300 that uses the moving picture coding method and the moving picture decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively (which function as the image coding apparatus and the image decoding apparatus according to the aspects of the present invention); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

As an example, FIG. 11 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

FIG. 12 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording block. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 10. The same will be true for the configuration of the computer ex111, the cellular phone ex114, and others.

FIG. 13A illustrates the cellular phone ex114 that uses the moving picture coding method and the moving picture decoding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 13B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the moving picture coding method shown in each of embodiments (i.e., functions as the image coding apparatus according to the aspect of the present invention), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation unit (modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in each of embodiments (i.e., functions as the image decoding apparatus according to the aspect of the present invention), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of embodiments can be used in any of the devices and systems described. Thus, the advantages described in each of embodiments can be obtained.

Furthermore, the present invention is not limited to embodiments, and various modifications and revisions are possible without departing from the scope of the present invention.

### Embodiment 3

Video data can be generated by switching, as necessary, between (i) the moving picture coding method or the moving picture coding apparatus shown in each of embodiments and (ii) a moving picture coding method or a moving picture coding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of embodiments will be hereinafter described. The multiplexed data is a digital stream in the MPEG-2 Transport Stream format.

FIG. 14 illustrates a structure of the multiplexed data. As illustrated in FIG. 14, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in each of embodiments, or in a moving picture coding method or by a moving picture coding apparatus in conformity with a conventional standard, such as MPEG-2, MPEG-4 AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary video to be mixed with the primary audio.

FIG. 15 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

FIG. 16 illustrates how a video stream is stored in a stream of PES packets in more detail. The first bar in FIG. 16 shows a video frame stream in a video stream. The second bar shows the stream of PES packets. As indicated by arrows denoted as yy1, yy2, yy3, and yy4 in FIG. 16, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

FIG. 17 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 17. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

FIG. 18 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

Each of the multiplexed data information files is management information of the multiplexed data as shown in FIG. 19. The multiplexed data information files are in one to one correspondence with the multiplexed data, and each of the files includes multiplexed data information, stream attribute information, and an entry map.

As illustrated in FIG. 19, the multiplexed data includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

As shown in FIG. 20, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In the present embodiment, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of embodiments includes a step or a unit for allocating unique information indicating video data generated by the moving picture coding method or the moving picture coding apparatus in each of embodiments, to the stream type included in the PMT or the video stream attribute information. With the configuration, the video data generated by the moving picture coding method or the moving picture coding apparatus described in each of embodiments can be distinguished from video data that conforms to another standard.

Furthermore, FIG. 21 illustrates steps of the moving picture decoding method according to the present embodiment. In Step exS100, the stream type included in the PMT or the video stream attribute information is obtained from the multiplexed data. Next, in Step exS101, it is determined whether or not the stream type or the video stream attribute information indicates that the multiplexed data is generated by the moving picture coding method or the moving picture coding apparatus in each of embodiments. When it is determined that the stream type or the video stream attribute information indicates that the multiplexed data is generated by the moving picture coding method or the moving picture coding apparatus in each of embodiments, in Step exS102, decoding is performed by the moving picture decoding method in each of embodiments. Furthermore, when the stream type or the video stream attribute information indicates conformance to the conventional standards, such as MPEG-2, MPEG-4 AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of embodiments can perform decoding. Even when multiplexed data that conforms to a different standard, an appropriate decoding method or apparatus can be selected. Thus, it becomes possible to decode information without any error. Furthermore, the moving picture coding method or apparatus, or the moving picture decoding method or apparatus in the present embodiment can be used in the devices and systems described above.

### Embodiment 4

Each of the moving picture coding method, the moving picture coding apparatus, the moving picture decoding method, and the moving picture decoding apparatus in each of embodiments is typically achieved in the form of an integrated circuit or a Large Scale Integrated (LSI) circuit. As an example of the LSI, FIG. 22 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of embodiments. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording media ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present invention is applied to biotechnology.

### Embodiment 5

When video data generated in the moving picture coding method or by the moving picture coding apparatus described in each of embodiments is decoded, compared to when video data that conforms to a conventional standard, such as MPEG-2, MPEG-4 AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

In order to solve the problem, the moving picture decoding apparatus, such as the television ex300 and the LSI ex500 is configured to determine to which standard the video data conforms, and switch between the driving frequencies according to the determined standard. FIG. 23 illustrates a configuration ex800 in the present embodiment. A driving frequency switching unit ex803 sets a driving frequency to a higher driving frequency when video data is generated by the moving picture coding method or the moving picture coding apparatus described in each of embodiments. Then, the driving frequency switching unit ex803 instructs a decoding processing unit ex801 that executes the moving picture decoding method described in each of embodiments to decode the video data. When the video data conforms to the conventional standard, the driving frequency switching unit ex803 sets a driving frequency to a lower driving frequency than that of the video data generated by the moving picture coding method or the moving picture coding apparatus described in each of embodiments. Then, the driving frequency switching unit ex803 instructs the decoding processing unit ex802 that conforms to the conventional standard to decode the video data.

More specifically, the driving frequency switching unit ex803 includes the CPU ex502 and the driving frequency control unit ex512 in FIG. 22. Here, each of the decoding processing unit ex801 that executes the moving picture decoding method described in each of embodiments and the decoding processing unit ex802 that conforms to the conventional standard corresponds to the signal processing unit ex507 in FIG. 22. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 3 is probably used for identifying the video data. The identification information is not limited to the one described in Embodiment 3 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 25. The driving frequency can be selected by storing the look-up table in the buffer ex508 and in an internal memory of an LSI, and with reference to the look-up table by the CPU ex502.

FIG. 24 illustrates steps for executing a method in the present embodiment. First, in Step exS200, the signal processing unit ex507 obtains identification information from the multiplexed data. Next, in Step exS201, the CPU ex502 determines whether or not the video data is generated by the coding method and the coding apparatus described in each of embodiments, based on the identification information. When the video data is generated by the moving picture coding method and the moving picture coding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method and the moving picture coding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG-4 AVC is larger than the processing amount for decoding video data generated by the moving picture coding method and the moving picture coding apparatus described in each of embodiments, the driving frequency is probably set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in each of embodiments, the voltage to be applied to the LSI ex500 or the apparatus including the LSI ex500 is probably set higher. When the identification information indicates that the video data conforms to the conventional standard, such as MPEG-2, MPEG-4 AVC, and VC-1, the voltage to be applied to the LSI ex500 or the apparatus including the LSI ex500 is probably set lower. As another example, when the identification information indicates that the video data is generated by the moving picture coding method and the moving picture coding apparatus described in each of embodiments, the driving of the CPU ex502 does not probably have to be suspended. When the identification information indicates that the video data conforms to the conventional standard, such as MPEG-2, MPEG-4 AVC, and VC-1, the driving of the CPU ex502 is probably suspended at a given time because the CPU ex502 has extra processing capacity. Even when the identification information indicates that the video data is generated by the moving picture coding method and the moving picture coding apparatus described in each of embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment 6

There are cases where a plurality of video data that conforms to different standards, is provided to the devices and systems, such as a television and a mobile phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

In order to solve the problem, what is conceived is a configuration in which the decoding processing unit for implementing the moving picture decoding method described in each of embodiments and the decoding processing unit that conforms to the conventional standard, such as MPEG-2, MPEG-4 AVC, and VC-1 are partly shared. Ex900 in FIG. 26A shows an example of the configuration. For example, the moving picture decoding method described in each of embodiments and the moving picture decoding method that conforms to MPEG-4 AVC have, partly in common, the details of processing, such as entropy coding, inverse quantization, deblocking filtering, and motion compensated prediction. The details of processing to be shared probably include use of a decoding processing unit ex902 that conforms to MPEG-4 AVC. In contrast, a dedicated decoding processing unit ex901 is probably used for other processing unique to an aspect of the present invention. The decoding processing unit for implementing the moving picture decoding method described in each of embodiments may be shared for the processing to be shared, and a dedicated decoding processing unit may be used for processing unique to that of MPEG-4 AVC.

Furthermore, ex1000 in FIG. 26B shows another example in that processing is partly shared. This example uses a configuration including a dedicated decoding processing unit ex1001 that supports the processing unique to an aspect of the present invention, a dedicated decoding processing unit ex1002 that supports the processing unique to another conventional standard, and a decoding processing unit ex1003 that supports processing to be shared between the moving picture decoding method according to the aspect of the present invention and the conventional moving picture decoding method. Here, the dedicated decoding processing units ex1001 and ex1002 are not necessarily specialized for the processing according to the aspect of the present invention and the processing of the conventional standard, respectively, and may be the ones capable of implementing general processing. Furthermore, the configuration of the present embodiment can be implemented by the LSI ex500.

As such, reducing the scale of the circuit of an LSI and reducing the cost are possible by sharing the decoding processing unit for the processing to be shared between the moving picture decoding method according to the aspect of the present invention and the moving picture decoding method in conformity with the conventional standard.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

1. A method of encoding video using adaptive interpolation filter length comprising the steps of:
writing a parameter into a header of a coded video stream to indicate a selected derivation scheme of interpolation filter length;
selecting a scheme among a plurality set of pre-determined schemes based on said written parameter for derivation of interpolation filter length;
deriving a set of interpolation filter coefficients from a plurality of pre-defined sets for interpolation filter coefficients using said selected derivation scheme;
performing a motion estimation process for a block of image samples based on said selected set of interpolation filter coefficients to derive a set of motion vectors;
performing a motion prediction process for said block of image samples based on said selected set of interpolation filter coefficients and said derived set of motion vectors; and
writing said set of motion vectors for said block into said coded video stream.

2. A method of decoding video using adaptive interpolation filter length comprising the steps of:
parsing a parameter from a header of compressed video stream to determine a scheme for derivation of interpolation filter length;
selecting a scheme among a plurality set of pre-defined schemes for derivation of interpolation filter length based on said parsed parameter from said compressed video stream;
deriving a set of interpolation filter coefficients from plurality of pre-defined sets for interpolation filter coefficients using said selected derivation scheme;
parsing a set of motion vectors from said coded video streams for a block of reconstructed image samples; and
performing a motion prediction process for said block of reconstructed image samples based on said selected set of interpolation filter coefficients and said parsed set of motion vectors.

3. The method of encoding video using adaptive interpolation filter length according to claim 1, whereas said plurality set of pre-defined schemes include a scheme where the derivation of interpolation filter length depends on spatial resolution of an image.

4. The method of encoding video using adaptive interpolation filter length according to claim 1, whereas said plurality set of pre-defined schemes include a scheme where the derivation of interpolation filter length depends on spatial resolution of a prediction block.

5. The method of encoding video using adaptive interpolation filter length according to claim 1, whereas said plurality set of pre-defined schemes include a scheme where the interpolation filter length is fixed to a pre-defined value.

6. The method of encoding video using adaptive interpolation filter length according to claim 1, whereas said scheme for deriving a set of interpolation filter coefficients comprising the steps of:
computing a spatial resolution of an image based on parsed parameters from a compressed video stream;
comparing said computed spatial resolution of the image with a predefined value;
wherein, when said computed spatial resolution of an image is smaller than predefined value,
selecting a first set of interpolation filter coefficients whose length is smaller than a second set of interpolation filter coefficients for said image;
wherein, when said computed spatial resolution of an image is not smaller than predefined value,
selecting said second set of interpolation filter coefficients for said image.

7. The method of encoding video using adaptive interpolation filter length according to claim 1, whereas said scheme for deriving a set of interpolation filter coefficients comprising the steps of:
computing a spatial size of a prediction block based on parsed parameters from a compressed video stream;
comparing said computed spatial size of the prediction block with a predefined value;
wherein, when said computed spatial size of the prediction block is smaller than predefined value,
selecting a first set of interpolation filter coefficients whose length is smaller than a second set of interpolation filter coefficients for said prediction block;
wherein, when said computed spatial size of the prediction block is not smaller than predefined value,
selecting said second set of interpolation filter coefficients for said prediction block.

8. The method of encoding video using adaptive interpolation filter length according to claim 1, whereas said parameter is a width of an image.

9. The Method of encoding video using adaptive interpolation filter length according to claim 1, whereas said parameter is a height of an image.

10. The method of encoding video using adaptive interpolation filter length according to claim 1, whereas said parameter is a profile parameter.

11. The method of encoding video using adaptive interpolation filter length according to claim 1, whereas said parameter is level parameter.

12. A apparatus of encoding video using adaptive interpolation filter length comprising the steps of:
writing unit operable to write a parameter into a header of a coded video stream to indicate a selected derivation scheme of interpolation filter length;
selecting unit operable to select a scheme among a plurality set of pre-determined schemes based on said written parameter for derivation of interpolation filter length;
deriving unit operable to derive a set of interpolation filter coefficients from a plurality of pre-defined sets for interpolation filter coefficients using said selected derivation scheme;
motion estimation unit operable to perform a motion estimation process for a block of image samples based on said selected set of interpolation filter coefficients to derive a set of motion vectors;
motion prediction unit operable to perform a motion prediction process for said block of image samples based on said selected set of interpolation filter coefficients and said derived set of motion vectors; and
writing unit operable to write said set of motion vectors for said block into said coded video stream.

13. A apparatus of decoding video using adaptive interpolation filter length comprising the steps of:
parsing unit operable to parse a parameter from a header of compressed video stream to determine a scheme for derivation of interpolation filter length;
selecting unit operable to select a scheme among a plurality set of pre-defined schemes for derivation of interpolation filter length based on said parsed parameter from said compressed video stream;
deriving unit operable to derive a set of interpolation filter coefficients from plurality of pre-defined sets for interpolation filter coefficients using said selected derivation scheme;
parsing unit operable to parse a set of motion vectors from said coded video streams for a block of reconstructed image samples; and
motion prediction unit operable to perform a motion prediction process for said block of reconstructed image samples based on said selected set of interpolation filter coefficients and said parsed set of motion vectors.

14. The apparatus of encoding video using adaptive interpolation filter length according to claim 12, whereas said plurality set of pre-defined schemes include a scheme where the derivation of interpolation filter length depends on spatial resolution of an image.

15. The apparatus of encoding video using adaptive interpolation filter length according to claim 12, whereas said plurality set of pre-defined schemes include a scheme where the derivation of interpolation filter length depends on spatial resolution of a prediction block.

16. The apparatus of encoding video using adaptive interpolation filter length according to claim 12, whereas said plurality set of pre-defined schemes include a scheme where the interpolation filter length is fixed to a pre-defined value.

17. The apparatus of encoding video using adaptive interpolation filter length according to claim 12, whereas said scheme for deriving a set of interpolation filter coefficients comprising the steps of:
computing unit operable to compute a spatial resolution of an image based on parsed parameters from a compressed video stream;
comparing unit operable to compare said computed spatial resolution of the image with a predefined value;
wherein, when said computed spatial resolution of an image is smaller than predefined value,
selecting unit operable to select a first set of interpolation filter coefficients whose length is smaller than a second set of interpolation filter coefficients for said image;
wherein, when said computed spatial resolution of an image is not smaller than predefined value,
selecting unit operable to select said second set of interpolation filter coefficients for said image.

18. The apparatus of encoding video using adaptive interpolation filter length according to claim 12, whereas said scheme for deriving a set of interpolation filter coefficients comprising the steps of:
computing unit operable to compute a spatial size of a prediction block based on parsed parameters from a compressed video stream;
comparing unit operable to compare said computed spatial size of the prediction block with a predefined value;
wherein, when said computed spatial size of the prediction block is smaller than predefined value,
selecting unit operable to select a first set of interpolation filter coefficients whose length is smaller than a second set of interpolation filter coefficients for said prediction block;
wherein, when said computed spatial resolution of the prediction block is not smaller than predefined value,
selecting unit operable to select said second set of interpolation filter coefficients for said prediction block.

19. The apparatus of encoding video using adaptive interpolation filter length according to claim 12, whereas said parameter is a width of an image.

20. The apparatus of encoding video using adaptive interpolation filter length according to claim 12, whereas said parameter is a height of an image.

21. The apparatus of encoding video using adaptive interpolation filter length according to claim 12, whereas said parameter is a profile parameter.

22. The apparatus of encoding video using adaptive interpolation filter length according to claim 12, whereas said parameter is level parameter.
